(19) United States
(12) Patent Application Publication
(10) Pub. No.: US 2007/0111789 A1
(43) Pub. Date: May 17, 2007

(54) Interactive online Internet game and method of determining winning players

(76) Inventors: Marc van Deursen, Den Bosch (NL); MarieClair van Iersel, Den Bosch (NL)

Correspondence Address: GREER, BURNS & CRAIN, 300 S WACKER DR, 25TH FLOOR, CHICAGO, IL, 60606, US

(21) Appl. No.: 11/273,335

(22) Filed: Nov. 14, 2005

(51) Int. Cl. A63F 13/00

(52) U.S. Cl. 463/40

(57) ABSTRACT

An interactive musical chair game residing on an Internet website that is accessible by a number of players is disclosed wherein the game causes the display of a page where a player can log on to play the game by supplying an identification such as an email address and/or password, causes the display of a first predetermined area for initially displaying an object associated with each logged-on player and a lesser number of chairs than the number of logged-on players, starts by playing or representing the playing of music while moving the objects relative to the chairs, stops the playing or representation of playing of music, permits the players to choose a chair and attempting to have their respective objects occupy the same, eliminates players whose object failed to occupy a chair, removes at least one addition chair and iteratively permits said starting, stopping, permitting and eliminating actions until one or more winners are determined wherein each winner is a player whose object occupied a chair. A method of determining one or more winners is also disclosed.

### BACKGROUND OF THE INVENTION

The present invention generally relates to online interactive websites.

Individuals and companies have been engaged in creative and other activity for ages to promote interest and sales of products and services. The advertising industry is a large and important part of commerce of the entire world. Over the decades, print advertising was probably the first mass marketing media, followed by radio and then television.

With the advent of the Internet, advertising has evolved in a many different ways that are often quite different from the forms of the past. Because of the structure and functionality of the Internet, interactivity with users opens up a whole new capability that can be used to advantage by advertisers and other promoters.

### SUMMARY OF THE INVENTION

An interactive real time musical chair game residing on an Internet website that is accessible by a number of players is disclosed wherein the game causes the display of a page where a player can log on to play the game by supplying an identification such as an email address and/or password, causes the display of a first predetermined area for initially displaying an object associated with each logged-on player and a lesser number of chairs than the number of logged-on players, starts by playing or representing the playing of music while moving the objects relative to the chairs, stops the playing or representation of playing of music, permits the players to choose a chair and attempting to have their respective objects occupy the same, eliminates players whose object failed to occupy a chair, removes at least one addition chair and iteratively permits said starting, stopping, permitting and eliminating actions until one or more winners are determined wherein each winner is a player whose object occupied a chair. A method of determining one or more winners is also disclosed.

### DESCRIPTION OF THE DRAWINGS

FIG. 1 is a page where a user can log onto a preferred embodiment of a musical chairs game for promoting and/or selling products and services.

FIG. 2-8 are representations of computer screen displays that occur during the play of the preferred embodiment of the present invention.

### DETAILED DESCRIPTION

The preferred embodiment of the present invention is for a real time Internet based fully interactive and online musical chair game for online promotions for various purposes. The game can be used to sell products and services, or promote the same. It can be used in connection with the website of a marketer or promoter of goods and services in a way that creates additional interest for the user, because it offers the competition of a game. Also, since the game of musical chairs is known throughout most of if not the whole world, the prospect of playing the game for some prize or benefit is often appealing to individuals of all ages. Unlike many modern computer games, any individual who is familiar with the game of musical chairs would have an intuitive feel for how it would be played and a feeling that it would not be difficult to play. These types of feelings are positive indicators for advertisers and/or promoters because they promote a sense of comfort and familiarity.

Because the game is known to incrementally reduce the number of players as play continues, the game is a perfect way to provide a benefit or prize to a reduced number of individuals from a larger number that start the game. For this reason, it is a good way to market stressed inventory, promote new initiatives or product launches, where users can participate in a online music chairs session through which products are won or inventory is auctioned.

One preferred use of the game is in connection with a travel oriented website, such as an airline carrier or a travel agency or reservation website. The game can be used to market the last few seats on a particular flight, for example, but can be used to market airline-tickets generally, hotel-rooms and complete holidays. The game would be accessed by people who want to book a last minute trip and want to take the chance of paying an absolutely low price for it. To play the game, people must log in and provide a password, which means that they must register with the website and provide their e-mail address and identity in the process. The website therefore has the name and address of potential customers they would like reach, who are then added to their database. The game therefore provides an added benefit to the website owner.

Another application of the game is to charge a registration fee for participating in a game for a prize or benefit that would be worth much more than the cost. For example, a round trip ticket from Chicago to Tokyo could be the winning prize in a game limited to 30 players who could enter the game for some fractional amount of the normal cost. The number of players is preferably limited between 5 and 30 players.

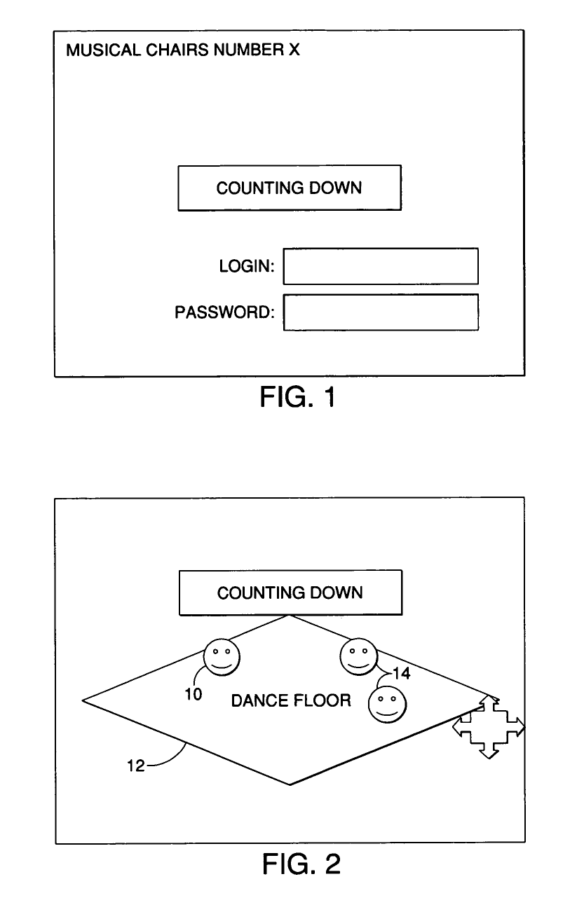

Turning now to the drawings, FIG. 1 shows the opening display after a player indicates, typically by clicking an icon on a website, that he (or she) wishes to play musical chairs for some prize or benefit. The prize or benefit is preferably associated with a particular game that may be identified by a number, for example. To play the game, and assuming it has an identification number or other indicator, the player will be required to login with their user name and password. Preferably, the display indicates when the game will start, either by posting the start time or an indication of a count down.

In this regard, a notice may be posted on the website that a musical chairs session will be used to market a particular prize and will occur at a particular date and time that may be several days in advance. Visitors to the website may register in advance for the session. Also, prior registrants may be notified of future sessions by e-mail or SMS in advance, so that they can register for particular sessions. Additionally, the website may send a reminder of the session shortly before its scheduled time to attempt to have registrants actually participate.

Broadly stated, the game starts with participating player icons or avatars (digital persons) moving around a group of chairs after the music starts and this continues until the music stops. The game is won by how fast one clicks their mouse on a chair near their player after the music stops. If their avatar is closer than other player avatars, they will reach the chair first and be seated. As many rounds as are needed will continue until the winner or winners are determined.

More particularly, and referring to FIG. 2, after the player logs in, their avatar 10, 14 is shown on a field 12 together with other avatars 14 which are added as more players join the game. While the illustrated embodiment has avatars in the form of smiley faces (which turn to frowney faces when they lose), the avatars may be in the form of more natural human characters or cartoon characters or even animals or an inanimate objects. Each player's display of their own avatar is distinguishable from other players, either by color, shape or dress. Since each player is participating on a separate computer, their own avatar can have a different color relative to the rest that are shown. Alternatively, it is within the spirit and scope of the invention that players may customize their own avatar to have a distinctive shape or physical characteristics, such as its outfit. The count down will continue until a pre-defined start time when the game commences with the number of avatars representing the number of players that have logged on. The game will start by starting the music and with some number of players and a smaller number of chairs that is determined by the game engine. If the number of chairs is one less than the number of players, the game will require one less rounds relative to the number of players to produce a single winner. If there are many players, such as twenty for example, it may be desirable to have two or more fewer chairs in the early rounds, to remove players more quickly. It is preferred that the number of players be within the range of about five to about twenty-five. For subsequent rounds, chairs are removed so that players are eliminated.

Because the start of the game is coincident with the start of the playing of music, and the players must try to find an unoccupied chair when the music stops, it is important to signal the start and stop of music visually because there may be some registrants that are playing the game on a computer that does not have installed speakers. For this reason, a musical note icon 18 is displayed when music is being played and a crossed out musical note icon 20 is displayed when the music stops.

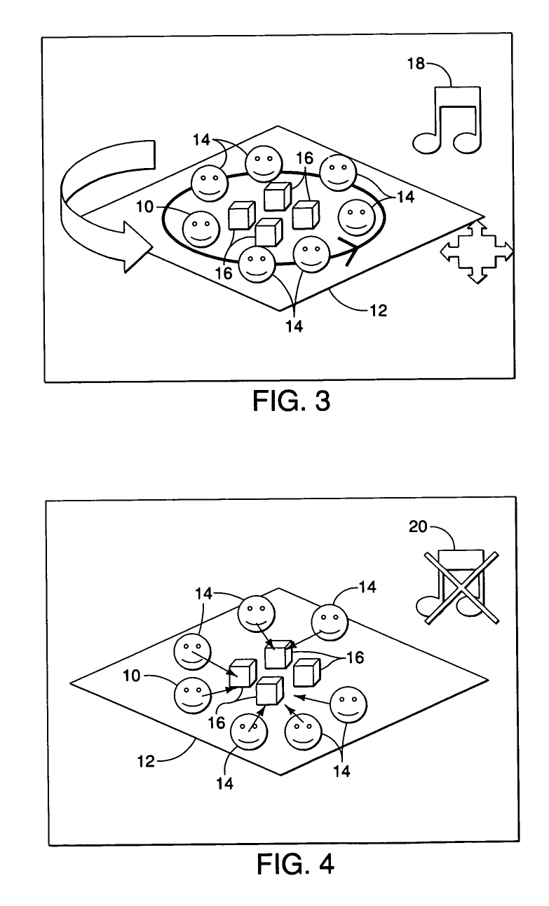

It is preferred that the avatars 10, 14 “dance” around chairs 16 while the music is playing as shown in FIG. 3, with the avatars moving in a “dancing” manner relative to one another and relative to the chairs 16 while generally moving in a clockwise or counterclockwise circle around the group of chairs Such “random” dancing movements can introduce some uncertainty that adds to the play of the game. The player can preferably use their mouse to influence the dancing movement, but the mouse will not enable the player to carefully control their avatar's location. In this regard, the site is preferably capable of being accessed a short time before the start of the session, e.g., 30 minutes, and has the music playing so that the players can hear the music and practice their ability to influence the dancing of their avatar.

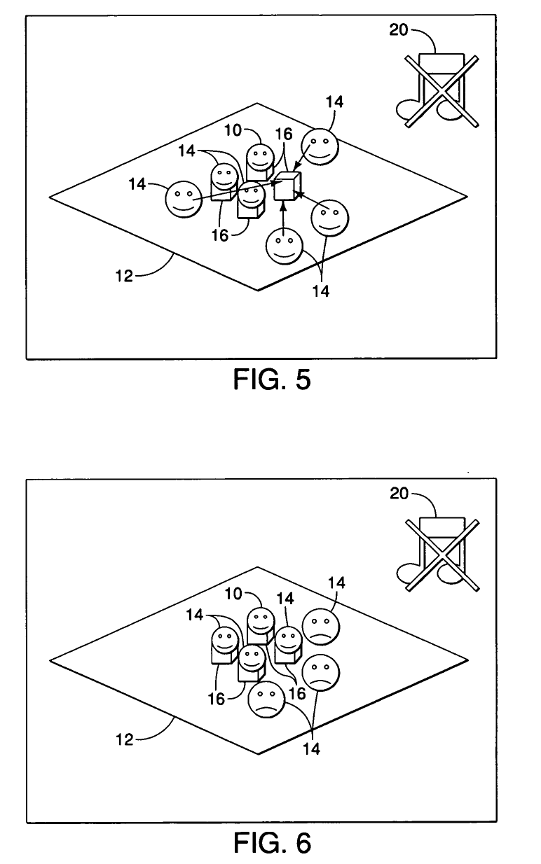

After some period of time dancing, the music is stopped as shown in FIG. 4, and all players must use their mouse to click the cursor on a seat 16 nearest their own avatar. The avatar will move directly to the seat and will sit down, unless another avatar is there first. If the seat is taken by another, the player can try to take another free seat (see FIG. 5). The result shown in FIG. 6 is that three of the avatars 16 were still standing and therefore eliminated, (hence the frowney face). While not required, it is preferred that when a player clicks a chair 16 before the music stops playing, the player is warned the first time and disqualified and loses the next time. The game preferably eliminates all players whose object failed to occupy a chair within a certain predetermined time after the music is stopped, even if there is an available empty chair. This permits the game to continue in spite of the fact that players may be distracted for some reason or their communication with the website is interrupted. While the “time out” period can be varied, it is preferred that it be about 30 seconds after the music stops.

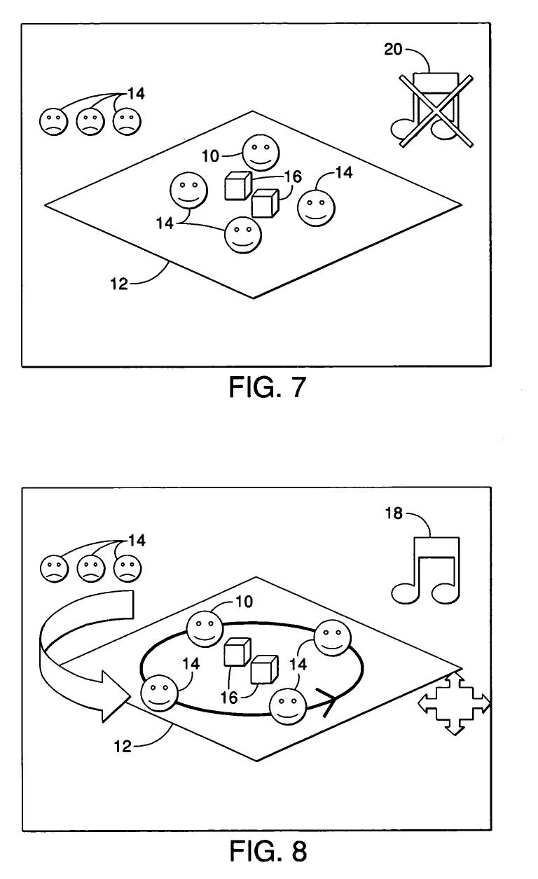

The remaining players then play another round, shown in FIGS. 7 and 8, which will reduce the players from four to two. A final round will produce a single winner. It is preferred that the game be completed in an elapsed time between about 2 and about five minutes, but the timing can be shortened or lengthened by varying the dancing time of each round, the number of players permitted and the number of players that are eliminated from each round.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

What is claimed is:

1. An interactive real time musical chair game residing on an Internet website that is accessible by a number of players, comprising:
the game causing the display of a page where a player can log on to play the game by supplying an identification and a password;
the game causing the display of a first predetermined area for initially displaying an object associated with each logged-on player and a lesser number of chairs than the number of logged-on players;
the game starting by playing or representing the playing of music while moving the objects relative to the chairs;
the game stopping the playing or representation of playing of music;
the game permitting the players to choose a chair and attempting to have their respective objects occupy the same;
the game eliminating players whose object failed to occupy a chair;
the game removing at least one addition chair;
the game iteratively permitting said starting, stopping, permitting and eliminating actions until one or more winners are determined, each winner being a player whose object occupied a chair.

2. An interactive game as defined in claim 1 wherein the game is accessible by a number of players within the range of about 5 to about 25.

3. An interactive game as defined in claim 1 wherein said object is one of a natural human character, cartoon characters, an animal or an inanimate objects.

4. An interactive game as defined in claim 1 wherein said objects are avatars that are distinguishable from one another by color, shape or dress.

5. An interactive game as defined in claim 1 wherein the representation of playing of music comprises a visual display of musical indicia.

6. An interactive game as defined in claim 1 wherein said musical indicia comprises one or more musical notes.

7. An interactive game as defined in claim 1 wherein said representation of stopping of playing of music comprises a visual display of musical indicia with at least one bar running across the same.

8. An interactive game as defined in claim 1 wherein the players choose a chair by using a computer mouse device to locate and click on a displayed chair.

9. An interactive game as defined in claim 1 wherein objects that are eliminated are displayed in a separate area outside of said first predetermined area.

10. An interactive game as defined in claim 1 wherein the game eliminates all players whose object failed to occupy a chair within a certain predetermined time after the music is stopped;

11. An interactive game as defined in claim 1 wherein the game moves the objects in a general path relative to the chairs and also moves the objects relative to one another in a generally random manner so that the objects move closer and farther away as they move in said general path.

12. An interactive game as defined in claim 11 wherein said general path is either generally clockwise or counterclockwise around said chairs.

13. An interactive game as defined in claim 11 wherein the players can use a computer mouse device or key board keys to at least partially control the random manner of movement of their respective objects.

14. An interactive game as defined in claim 13 wherein the game permits the players to log on to the game and practice controlling the random manner of movement of their respective object prior to the start of the game.

15. An interactive method of determining one or more winners from a group of players, comprising the steps of:
a) providing a website having a musical chairs game residing thereon;
b) up to a predetermined number of players logging onto the website from a computing device having a cursor control;
c) said website providing a first predetermined area for initially displaying an object associated with each of said logged-on players and a lesser number of chairs than the number of said logged-on players;
d) said website starting the playing the game including playing or representing the playing of music while moving the objects relative to the chairs;
e) said website stopping the playing or representation of playing of music;
f) the players choosing a chair and attempting to have their respective objects occupy the same;
g) said website eliminating players whose object failed to occupy a chair;
h) said website removing at least one addition chair and repeating steps d), e), f) and g) until one or more winners are determined, each winner being a player whose object occupied a chair.

16. An interactive method as defined in claim 15 wherein the game is accessible by a number of players within the range of about 5 to about 25.

17. An interactive method as defined in claim 15 wherein said object is one of a natural human character, cartoon characters, an animal or an inanimate object.

18. An interactive method as defined in claim 15 wherein the representation of playing of music comprises a visual display of musical indicia.

19. An interactive method as defined in claim 15 wherein said representation of stopping of playing of music comprises a visual display of musical indicia with at least one bar running across the same.

20. An interactive method as defined in claim 15 wherein the players choose a chair by using a computer mouse device to locate and click on a displayed chair.

21. An interactive method as defined in claim 15 wherein objects that are eliminated are displayed in a separate area outside of said first predetermined area.

22. An interactive method as defined in claim 15 wherein said website eliminates all players whose object failed to occupy a chair within a certain predetermined time after the music is stopped;

23. An interactive method as defined in claim 15 wherein said website moves the objects in a general path relative to the chairs and also moves the objects relative to one another in a generally random manner so that the objects move closer and farther away as they move in said general path.

24. An interactive method as defined in claim 22 wherein said general path is either generally clockwise or counterclockwise around said chairs.

25. An interactive method as defined in claim 23 wherein the players can use a computer mouse device to at least partially control the random manner of movement of their respective objects.

26. An interactive game as defined in claim 25 wherein said website permits the players to log on to the game and practice controlling the random manner of movement of their respective object prior to the start of the game.
